(19) United States
(12) Patent Application Publication
(10) Pub. No.: US 2014/0189042 A1
(43) Pub. Date: Jul. 3, 2014

(54) METHOD FOR CAPTURING VIDEO RELATED CONTENT

(71) Applicants: Jianfeng Chen, Beijing (CN); Xiaojun Ma, Beijing (CN); Yanfeng Zhang, Beijing (CN)

(72) Inventors: Jianfeng Chen, Beijing (CN); Xiaojun Ma, Beijing (CN); Yanfeng Zhang, Beijing (CN)

(73) Assignee: Thomson Licensing, Issey de Moulineaux (FR)

(21) Appl. No.: 14/241,445

(22) PCT Filed: Sep. 1, 2011
(86) PCT No.: PCT/CN2011/079253

§ 371 Date: Feb. 26, 2014

(51) Int. Cl. H04L 29/08

(52) U.S. Cl. CPC H04L 67/2842
USPC 709/213

(57) ABSTRACT

Its provided a method for publishing content relating to a video being displayed on a first device, using a control device in communication with the first device via a wired or wireless connection. At the side of the control device, the method comprises the steps of sending a command for capturing to the first device for generating at least one picture or video clip from video data cached by the first device; receiving the at least one picture or video clip from the first device; presenting the at least one picture or video clip for the user to choose the content to publish; and sending the content for publication to a destination.

### TECHNICAL FIELD

The present invention relates to data communication, and more particularly, relates to a method for capturing video related content.

### BACKGROUND

A social networking service is an online service, platform, or site that focuses on building and reflecting of social networks or social relations among people who share interests with others by publishing content in the form of text, picture (or photo, image), video clip, etc. Most social network services are web based and provide means for users to interact over the internet, such as e-mail and instant messaging. After creating an account in a social networking service, a user can upload pictures of himself to his profile, upload pictures to his album(s) for others to browse, post blog entries for others to read, search for other users with similar interests, and compile and share lists of contacts. Besides social networking services, users can also publish content on an online forum, or on a video sharing web site. Herein, an online forum (or Internet forum, message board) is an online discussion web site where people can hold conversations in the form of posted messages. In recent days, people are more willing to enjoy personalized services, not only in the IP connecting service such as web browsing, but also in the traditional TV watching experience. In general, the content to be published is well prepared in advance, especially for the content in the form of text, picture (or photo, image), video clip, etc. Somebody may also have an instant interest for a specific scene of a video he or she is viewing, for example, a perfect goal in a football match, or a piece of funny news in the TV. However, when he decides to publish a snapshot of this event, for example to his blog, it's usually too late for him to capture the screen picture of the specific scene. After the sports game or the TV program, he may search the relating content through the web searching engine, but the relating content may be too hard to find. Moreover, it's not easy to locate the specific scene after finding the relating content. Therefore, for these instant interests during TV watching, most people are unwilling to do such effort capture and publish the relating snapshots because of inconvenience. In order to implement the sharing experience and interactivity dedicated for the instant interest when viewing TV program, a system to combine the TV watching and messaging platform is proposed in a patent application WO2006/074304 to improve the communication among a group list for the community viewing, rating and recommendation. The solution proposed is to enhance the viewer's communication with other users in his buddy list during TV watching, and it only describes the events like joining an on-line game, receiving in response to listening to music, etc. However, it cannot be used for handling the instant interest that is associated with a very specific scene or a short clip of the TV content.

### SUMMARY

According to an aspect of present invention, it's provided a method for capturing content relating to a video being displayed on a first device with a control device having a display and in communication with the first device via a wired or wireless connection. At the side of the first device, it comprises the steps of caching data of the video; receiving a command for capturing from the control device; generating at least one picture or video clip from the cached data; and sending the generated at least one picture or video clip to the control device.

According to another aspect of present invention, it's provided a method for publishing content relating to a video being displayed on a first device, using a control device in communication with the first device via a wired or wireless connection. At the side of the control device, the method comprises the steps of sending a command for capturing to the first device for generating at least one picture or video clip from video data cached by the first device; receiving the at least one picture or video clip from the first device; presenting the at least one picture or video clip for the user to choose the content to publish; and sending the content for publication to a destination.

According to another aspect of present invention, it's provided a control device for publishing content relating to a video being displayed on a first device, wherein, the control device is in communication with the first device via a wired or wireless connection. The device comprises: a network interface for sending a command for capturing to the first device for generating at least one picture or video clip from video data cached by the first device, and receiving the at least one picture or video clip from the first device; a data reception module for storing the received at least one picture or video clip; and a user interface for presenting the at least one picture or video clip for the user to select the content to publish; wherein, upon user's selection, the network interface is further configured to send the content for publication to a destination.

More aspects and advantages of the invention will be found in the following detailed description of the present invention with accompanying drawings. It is to be understood that the following description relates to embodiments which are not limitative to the scope of the invention.

### BRIEF DESCRIPTION OF THE DRAWINGS

FIG. 1 is a block diagram showing a system for publishing TV video related content according to an embodiment of present invention;

FIG. 2 is a block diagram showing an embodiment of present invention; and

FIG. 3 is a flow chart showing a method for publishing TV video related content at the side of the control device according to the embodiment of present invention.

### DETAILED DESCRIPTION

An embodiment of the present invention will now be described in detail in conjunction with the drawings. In the following description, some detailed descriptions of known functions and configurations may be omitted for clarity and conciseness.

According to an embodiment of present invention, the user can publish the content associated with an instant interest for a specific scene of a TV program to his personal web space during the TV watching. Specifically, a control device (for example a tablet) besides the Set Top Box (with TV connected), is used to capture the user's command when the interested content emerges, then it sends a command to the Set Top Box (STB) for retrieving the corresponding content (e.g. picture, audio, video clip) displayed in a time interval that includes the time position associated with the command. The returned content after retrieving is displayed on the screen of the control device and the user can select one or more of them depending on his personal favor. He can also add some text comments to the selected content. Finally, the overall content (i.e. the selected content and the text comments) is published to his personal web spaces (e.g. blog or micro blog) via the wired network interface (e.g. Ethernet, Fiber) or wireless network interface (e.g. WiFi, 2G/3G, WiMAX, Long Term Evolution) from the control device. Furthermore, during the process of the content retrieving from the STB, additional fixed format information such as channel ID, program name, time stamp can be automatically inserted into, or attached to the content. The additional fixed format information can be uploaded to the server simultaneously when the content is published. Some third party web services such as search engines can detect this information for more accurate targeting and recommendation. Moreover, this information can be used for statistics of the published content.

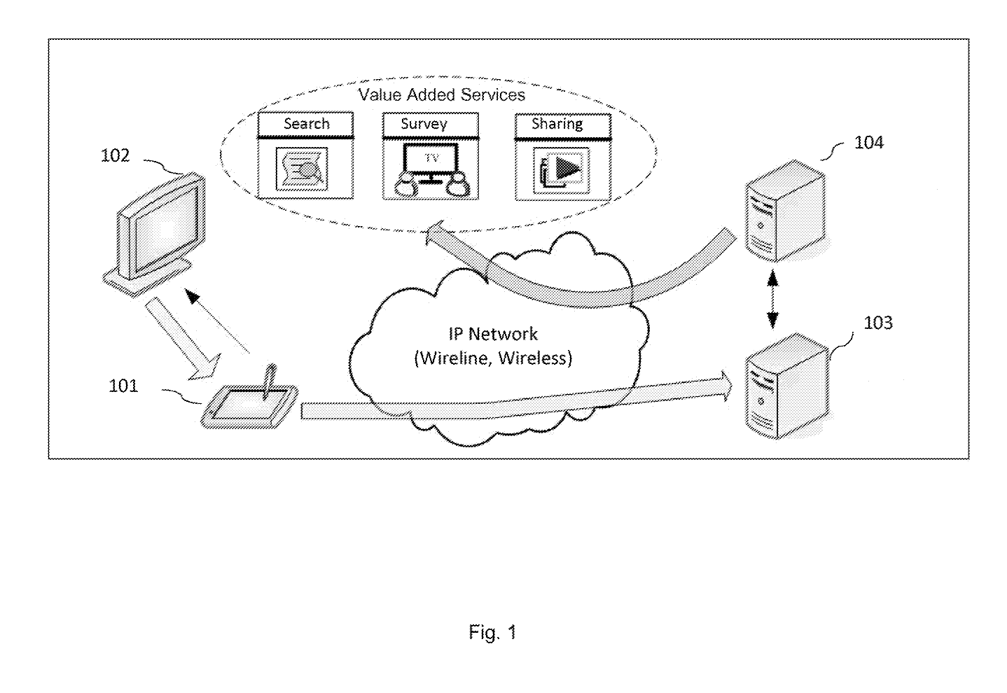

FIG. 1 is a block diagram of a system for publishing TV video related content according to an embodiment of present invention. The system comprises a control device 101, a first device 102 which usually is a STB with a TV connected to (or a TV with capability of caching video frames), a social network service server 103 and a statistics engine 104. The STB 102 is used to receive one or more video streams from TV broadcaster(s) via air broadcast, satellite, fiber optic, cable or IP connection. The server 103 is used to provide a social network service and application program interface for the control device 101 to invoke so as to publish content. Generally, user's account name, password and content to be published (including but not limiting to comments and pictures) are needed by the application program interface for publication. The control device 101 connects to the server 103 via Internet and connects to the STB 102 via either wired or wireless connection. It could be a tablet with a touch screen, PC, laptop as long as it can perform the functions described below. The control device 101 is used to obtain several pictures that are screen snapshots of the TV video what the user just watched from the STB 102, and allow user to select one or more pictures from the snapshot pictures to publish along with his inputted comments if any after presenting the snapshot pictures to the user. Here, in order to get the screen snapshots of the TV video, the STB 102 should be modified to cache the played TV video for a period of time. So the STB 102 is able to capture several snapshot pictures from the cached data in response to a picture capturing command (e.g. including a time position associated with the command and expected retrieved content form) sent by the control device 101. Here, when capturing the snapshot pictures, some fixed format information (e.g. channel ID, program name, timestamp) is inserted into or attached to the snapshot pictures and sent to the control device with the snapshot pictures. The richness of the fixed format information depends on the accompanying metadata information delivered with the TV content. For example, if the digital EPG (Electrical Program Guide) is available during the TV program transmission, it is possible to provide more fixed format information compared to programs without EPG supporting. Since all the fixed format information is copied from the corresponding settings by broadcaster (i.e. a unified source), if multiple users make requests for a same TV program in a same channel by using different control devices, the fixed format information will remain the same. So it makes statistics possible. Besides, the number of snapshot pictures can be preconfigured in the STB 102, or conveyed in a parameter included in a command, e.g. the picture capturing command, sent from the control device 101. The statistics engine 104 regularly accesses the server 103 and makes information aggregation or statistics based on the fixed format information, and possibly user comments. For example, many users may publish snapshot pictures at different time position of a same TV program. We can make statistics of the TV program by using the channel ID and program name in the fixed format information as index information. Moreover, the statistics result can be used by many value added services, e.g. including but not limiting to search service, survey service (e.g. to calculate how many viewers are interested in a specific TV program), sharing service (e.g. funny news snapshot in the last week), etc. The statistics engine 104 may be a service platform linked to the server 103.

Below describes an example of a user case according to the embodiment. When a user spots an interesting scene during the TV watching, he clicks a button on the touch screen in the control device 101 for requesting the STB 102 to capture content. Then a request command responsive to the button click is sent to the STB 102 to retrieve the captured content of the current TV program. Some parameters are carried in the request command, including a time position indicating when the button is clicked, expected content form, etc. As to the time position, if the program playing status can be checked, the current playback time position is used; if not, the system time clock is used. Assuming the expected content form is picture, the STB will send back a series of snapshot pictures of TV program in a time interval determined by the time position carried in the request message. Besides, some fixed format information such as channel ID (”xxx“) and program name (”yyy“) is automatically added into the snapshot pictures. The user can browse snapshot pictures and select one or more of them based on his favor. After he clicks a publishing button on the screen of the control device 101, an edition window pops up and allows him to input some text information for the title, comments etc. And at the same time, the fixed format information is transferred into the default key words field to provide indexing. Furthermore, in the edition window, the insertion of content of other type (e.g. animation, picture, etc.) can also be allowed. When the user finishes editing, he can publish this content to his personal web space in the server 103 after login process with his user account (account name and password). Finally, in the personal web space, a new item is added with the text information and the selected snapshot picture(s). Herein, whether or not to show the fixed format information, i.e. TV channel ID “xxx” and program name “yyy” in the new item depends on the configuration of the server 103, or user selection before the publishing.

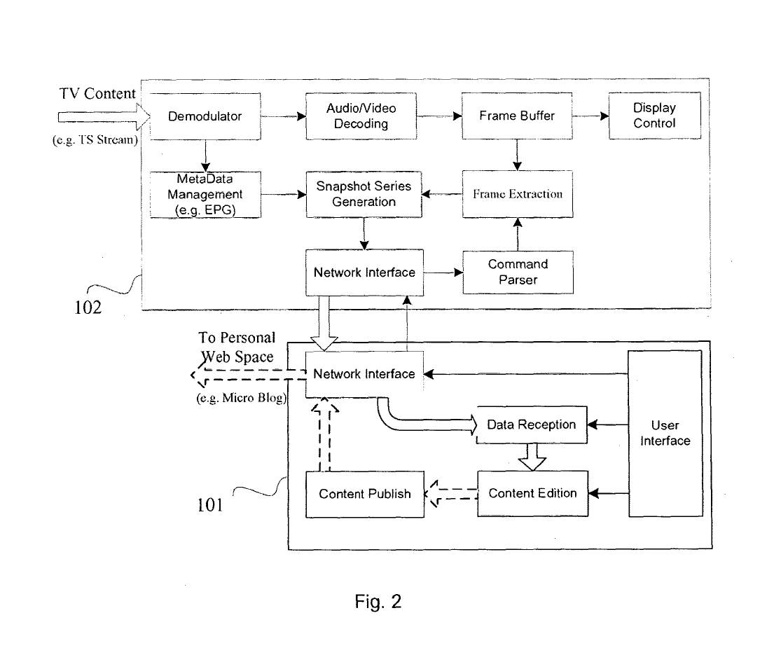

FIG. 2 is a block diagram showing the STB 102 and the control device 101 according to the embodiment. In the STB 102, the incoming TV content can be any type of the TV content available in the market, from satellite, cable, fiber, IPTV, Web TV, etc. After the demodulation of the TV stream, the metadata information (e.g. EPG information) and the audio/video content are separated. The frame sequence (e.g. 24 frames per second in one example) after the decoding will be stored in the frame buffer and transmit to the display control unit for the presentation on the TV screen. When the STB 102 receives a request command from the control device 101 through the network interface, it will be parsed and the corresponding parameters are obtained. The time position parameter will be sent to the frame extraction model to index which part of the frames in a given time interval is required. For example, if the time position of the capture command is 0 minute 30 second after the program beginning, and the extra 2 seconds are defined as the boundary for the frame extraction. The frame extraction module will extract some key frames displayed from 0 minute 28 to 32 second in the frame buffer. Many selection algorithms can be deployed in the real product, one embodiment is to select frames in a fixed time interval. Assuming there are 24 frames available per second, if 1 frame is selected every 8 frames, then totally 15 frames will be captured as the representative frame series in time line from 0 minute 28 to 32 second. Besides, fixed format information copied from the metadata management module will be added into these selected frames in the snapshot series generation module. Below is a table showing an example of additional information (including fixed format information) associated with the frame series or every frame. It shall be noted the richness of the additional information depends on how much metadata information is transmitted to the receiver from the TV broadcaster.

TABLE 1

| Syntax | Value | Comment |
|---|---|---|
| Date | 2010-12-24 | |
| Start Time Position | 0:0:28 | Start point for frame |
| | | extraction, |
| | | 0 minute 28 second |
| End Time Position | 0:0:32 second | End point for frame |
| | | extraction, |
| | | 0 minute 32 second |
| Channel ID | 0x 24 | Program ID in the Program |
| | | Map Table (take MPEG TS |
| | | for example) |
| Channel Name | China Central TV | |
| Program Name | Daily Sports News | |
| Program Category | Sport | Which type of the program |
| . . . | . . . | . . . |

In the control device 101, when it receives the snapshot series via the network interface, the data is stored in the data reception module. Then the snapshot series are displayed on the screen for the browsing of the user. The user can do any picture viewing operation in the control device 101, including but not limited to—next picture, previous picture, zoom out, zoom in, area selection, cut the margin, rotate, color change, pattern transformation, etc. He may select one or more pictures and then make the decision to share and publish them into his personal web space. Before publishing, he can add comments and title of the content in an editor window, then the publishing process will invoke the network interface by HTTP or HTTPS connection and send the corresponding picture and text information to the dedicated personal web space. According to a variant embodiment, some web space service provider may provide an independent client application that integrates functions of editing and publishing. In this case, the process will be simplified by invoking the client application to do the edition and publishing.

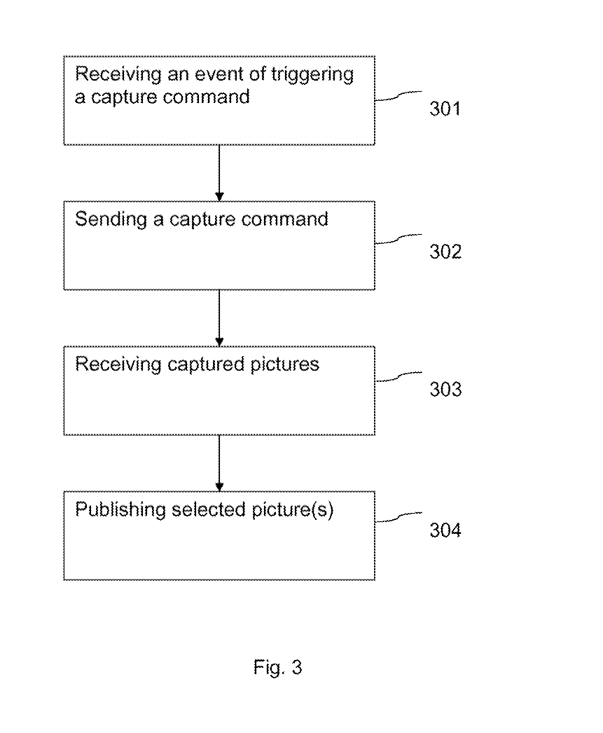

FIG. 3 is a flow chart showing a method for publishing TV video related content at the side of the control device 101 according to another embodiment of present invention. In this example, the STB 102 is configured or modified to cache the played video frames of the TV video for a predefined period of time, e.g. 1 minute, after the corresponding frames are played on the TV and is configured or modified to, in response to a capture command from the control device 101, capture a predefined number of pictures (e.g. 15 pictures) from the cached TV video, or cached TV video frames to be more specific in this example.

In the step 301, the control device 101 receives an event of triggering a capture command. For example, the control device 101 presents a capture button on its screen to the users. Upon press of the button by the user when he watches something interesting on the TV, the control device 101 will send a capture command for instructing the STB 102 to capture pictures from the cached video frames.

In the step 302, the control device 101 sends a capture command to the STB 102. After the STB 102 receives the capture command, it will randomly capture 15 pictures from the cached video frames.

In the step 303, the control device 101 receives the captured pictures and presents the captured pictures to the user. The pictures can be presented on the screen of the control device 101 in various patterns for display, e.g. they are arranged in a row on the top or bottom of the screen and scrollable for browsing, or they are arranged on the screen as a rectangular block with proportional spacing to each other. A person skilled in the art will appreciate that other patterns can also be used for facilitating the browsing of the pictures.

In the step 304, the control device 101 publishes selected picture(s) along with user's comments if any to the sever 103. Specifically, after the user selects one or more pictures, the control device 101 provides text box(s) for the user to input his comments. After the user instructs the control device 101 to publish the selected pictures along with his comments if he inputs any, the control device 101 will invoke the application program interface provided by the server 103 with pre-stored or pre-configured account name, password, the selected pictures and comments if any.

According to a variant, in the step 303, the control device 101 also receives the fixed format information or information more than the fixed format information as shown in the table 1, which is sent along with the captured pictures. It should be noted that a person skilled in the art can propose other information when implementing the present invention. Whether or not to display the information or part of the information depends on the user's selection or configuration of the control device 101. Besides, the information can be published along with the selected picture(s) in the step 304.

According to a variant, other than randomly capturing pictures from the cached video frames, the STB 102 captures, periodically with a predefined time interval (e.g. 2 seconds), pictures from a starting position in time (e.g. 40 seconds before the time when the STB 102 receives the capture command). Herein, the predefined time interval and/or the starting position in time can be preconfigured in the STB 102, or designated by the user and transmitted either along with the capture command or alone in a separate command. In the latter case where they are designated by the user, the control device 101 needs to provide an input interface for the user to designate the values.

According to another variant, the starting position in time is a time point preceding, in a predefined time period (e.g. 40 seconds), to when the control device 101 receives an event to triggering the capture command. In this case, the control device 101 needs to records its current time immediately after receiving the event, and sends the recorded time to the STB 102.

According to another variant, the control device 101 provides an input interface allowing the user to choose or input the number of pictures he wants the STB 102 to capture from the cached video frames. And the chosen or inputted number will be sent to the STB 102 either along with the capture command or alone in a separate command.

According to another variant, the STB 102 returns in response to the capture command one or more video clips instead of pictures. Similar to above examples, the duration of the video clip can be preconfigured in the STB 102, or designated by the user via an input interface on the control device 101. If only one video clip will be captured, the user can designate the starting time.

According to another variant, the control device 101 provides an input interface allowing the user to choose a form between picture and video clip in which the content will be captured and returned by the STB 102. The chosen form will be sent to the STB 102 either along with the capture command or alone in a separate command.

According to another variant, besides the traditional cable TV, the present invention can be applied to Internet video, e.g. VoD (video on demand), Internet TV, where the STB 102 is replaced by e.g. a PC, Internet TV etc.

According to a third embodiment, the functions of the control device 101 can be integrated into the STB 102. In this case, the user inputs, e.g. triggering capturing pictures or video clips, selecting picture(s), inputting his comments, publishing the pictures or video clips etc. shall be accomplished by the remote or other peripheral devices, e.g. a peripheral keyboard. Besides, since there is only one screen for display, when the capture function is activated, the screen is exclusively occupied by the capture function till it is finished. It means the TV video is not displayed. In a variant, upon the activation of the capture function, the screen is divided into two regions, one for the display of the TV video and the other for the display of the capture function.

According to a variant, the selected picture(s) or video clip(s) is sent to an IP address or a phone number. Herein, the IP address and the phone number identify a device, e.g. a PC or a mobile phone.

1. A method for capturing content relating to a video being displayed on a first device with a control device, wherein the control device is in communication with the first device via a wired or wireless connection, comprising, at the side of the first device, the steps of
caching data of the video for a period of time after it has been displayed by the first device;
receiving a capturing command from the control device;
generating at least one picture or video clip from the cached data; and
sending the generated at least one picture or video clip to the control device,

2. (canceled)

3. The method of the claim 1, wherein, it further comprises presenting by the first device in a region of a screen of the first device the at least one picture or video clip generated from the cached data.

4. The method of the claim 1, wherein, at least one of the following information is generated for the at least one picture or video clip: channel ID, channel name, program name, and program category.

5. The method of the claim 1, wherein, the at least one picture or video clip is generated based on a time value associated with the command for capturing.

6. A method for publishing content relating to a video being displayed on a first device, using a control device in communication with the first device via a wired or wireless connection, comprising, at the side of the control device, the steps of
sending a capturing command to the first device for generating at least one picture or video clip from video data cached by in the first device, wherein the video data is cached in the first device for a period of time after it has been displayed by the first device;
receiving the at least one picture or video clip from the first device;
presenting the at least one picture or video clip; receiving a selection among at least one picture or video clip; and
sending selected content for publication to a destination.

7. The method of the claim 6, wherein the destination is a website, an IP address, or a phone number.

8. The method of the claim 6, wherein, it further comprises receiving at least one comment from the user to publish along with the content chosen to publish.

9. The method of the claim 6, wherein, presenting by the control device at least one interface for receiving at least one of the following inputs from the user: in which format the first device will generate the at least one picture or video clip from the cached data; the number of pictures or video clips the first device will generate; and a time duration the first device will generate for each video clip.

10. The method of the claim 6, further receiving from the first device at least one of the following information along with the received at least one picture or video clip: channel ID, channel name, program name, and program category.

11. The method of the claim 10, wherein the received information is published along with the content chosen to be published.

12. The method of the claim 6, wherein, the capturing command includes a time value for assisting to generate the at least one picture or video clip.

13. A control device for publishing content relating to a video being displayed on a first device, wherein, the control device is in communication with the first device via a wired or wireless connection, comprising:
a network interface for sending a capturing command to the first device for generating at least one picture or video clip from video data cached by the first device, and receiving the at least one picture or video clip from the first device, wherein the video data is cached in the first device for a period of time after it has been displayed by the first device;
a data reception module for storing the received at least one picture; and
a user interface for presenting the at least one picture or video clip;
wherein, upon user's selection among at least one picture or video clip, the network interface is further configured to send the content for publication to a destination.

14. (canceled)

15. The control device of the claim 13, wherein, the user interface is further configured to present at least one interface for receiving at least one of the following inputs from the user: in which format the first device will generate the at least one picture or video clip from the cached data; the number of pictures or video clips the first device will generate; and a time duration the first device will generate for each video clip.

16. A device for capturing content related to a video being displayed, comprising
a buffer for caching data of the video for a period of time after it has been displayed;
a network interface for receiving and sending data;
a generation module for in response to a capturing command received from a control device via the network interface generating at least one picture or video clip from the cached data and sending the generated at least one picture or video clip to the control device via the network interface.

17. Computer program product downloadable from a communication network and/or recorded on a medium readable by computer and/or executable by a processor, comprising program code instructions for implementing the steps of a method according to claim 1.
